(19) United States
(12) Patent Application Publication
(10) Pub. No.: US 2018/0039068 A1
(43) Pub. Date: Feb. 8, 2018

(54) Optical magnifying combination lens, head-mounted display optical system and virtual reality display device

(71) Applicant: IDEALENS TECHNOLOGY (CHENGDU) CO., LTD., Chengdu, Sichuan (CN)

(72) Inventors: Qinhua Huang, Chengdu, Sichuan (CN); Haitao Song, Chengdu, Sichuan (CN)

(21) Appl. No.: 15/555,554

(22) PCT Filed: Oct. 28, 2015
(86) PCT No.: PCT/CN2015/093084

§ 371 Date: Sep. 5, 2017

(30) Foreign Application Priority Data
Mar. 6, 2015 (CN) 201510100253.0
Mar. 6, 2015 (CN) 201520130502.6
Mar. 6, 2015 (CN) 201520130687.0

(51) Int. Cl. G02B 25/00; G02B 1/04; G02B 13/16; G02B 13/18; G02B 3/08

(52) U.S. Cl. CPC G02B 25/008; G02B 25/004; G02B 13/18; G02B 3/08; G02B 13/16; G02B 1/041

(57) ABSTRACT

An optical magnifying combination lens, head-mounted display optical system and virtual reality display device. The optical magnifying combination lens (2) is used in a head-mounted virtual reality display device and includes a main lens (21) and a secondary lens (22), the main lens (21) including a central area (A) and an peripheral area (B), wherein the central area (A) comprises a convex lens or a combined convex lens, and the peripheral area (B) is a focusing thin optical element. The secondary lens (22) is a focusing thin optical element formed with a hollowed-out region. The main lens (21) and the secondary lens (22) are stacked together, and the hollowed-out region of the secondary lens (22) closely fits with a convex portion of the central area (A) of the main lens (21). The display device using the optical magnifying combination lens (2) ensures central image quality, and expands a peripheral field of view of a human eye, thus increasing user immersion.

### CROSS REFERENCE OF RELATED APPLICATION

This is a U.S. National Stage under 35 U.S.C 371 of the International Application PCT/CN2015/093084, filed Oct. 28, 2015, which claims priority under 35 U.S.C. 119(a-d) to CN 201510100253.0, filed Mar. 6, 2015; CN 201520130502.6, filed Mar. 6, 2015; CN 201520130687.0, filed Mar. 6, 2015.

### BACKGROUND OF THE PRESENT INVENTION

### Field of Invention

The present invention relates to the optical field, and more particularly to an optical magnifying combination lens applied on a head-mounted display device and the head-mounted display optical system and the head-mounted virtual reality display device with the optical magnifying combination lens.

### Description of Related Arts

The optical amplification elements of the head-mounted virtual reality display system adopt the conventional lens, such as the spherical lens, aspheric lens or free-form optical lens etc. Being limited by the optical processing techniques and the optical material, the diameter of the optical magnifying lens is normally small (due to big-diameter lens significantly increases the weight and volume of the optical system). The field of vision of the user through the optical magnifying lens set is limited by the diameter of the magnifying lens set. The field of vision through the magnifying lens set is smaller than the field of vision of the human eyes in natural state. The visual impact for and immersion of the human eyes are significantly affected by the limited field of vision through the image display system.

To enlarge the field of vision through the head-mounted virtual reality display system while the small volume and light weight of the head-mounted device are ensured is a problem need to be solved.

### SUMMARY OF THE PRESENT INVENTION

An object of the present invention is to provide a solution to enlarge the field of vision through the head-mounted virtual reality display system while the small volume and light weight of the head-mounted device are ensured. One of the embodiment of the present invention provides an optical magnifying combination lens which are applied in the in the head-mounted virtual reality display device, wherein the optical magnifying combination lens comprises main lens and secondary lens;

the main lens comprises a central area and a peripheral area; the central area comprises convex lens or combined convex lens; the peripheral area is a focusing thin optical element, a diameter-thickness ratio of which is equal to or greater than 10;

the secondary lens is a focusing thin optical element formed with a hollow-out region;

wherein the main lens is stacked with the secondary lens; the hollow-out region of the secondary lens is closely fit with a convex portion of the central area of the main lens.

According to one embodiment of the present invention, when the main lens is stacked with the secondary lens, the peripheral area of the main lens is partially or fully stacked with the secondary lens.

According to one embodiment of the present invention, a sinking overlapping edge lies in an internal edge of the secondary lens; the overlapping edge fits the peripheral area of the main lens.

According to one embodiment of the present invention, a difference between an overlapping focal length of the peripheral area of the main lens and the secondary lens and a focal length of the central area of the main lens is less than 10 millimeters.

According to one embodiment of the present invention,

the convex lens is spherical lens, aspheric lens or free-form optical lens; and/or,

the secondary lens is Fresnel lens, Fresnel zone plate or a binary optical element.

According to one embodiment of the present invention, the convex lens of the central area of the main lens is aspheric lens; the peripheral area of the main lens and the secondary lens is Fresnel lens of a same shape and size on a flat substrate.

According to one embodiment of the present invention, lines for removing chromatic aberration are on a surface of the convex lens.

According to one embodiment of the present invention, the main lens is stacked with the secondary lens by optical cement.

According to one embodiment of the present invention, the central area of the main lens and the peripheral area are integrated injection molding.

According to one embodiment of the present invention, the main lens comprises the central area or two symmetrical central areas; a number of the hollow-out region of the secondary lens is same with a number of the central area of the main lens.

Another object of the present invention is to provide a head-mounted display optical system, wherein the optical system comprises an image display source and an optical magnifying lens set, wherein the image display source is for displaying optical information; the optical information is magnified by the optical magnifying lens set to form a projection virtual image which is receive by human eyes; wherein the optical magnifying lens set comprises at least one piece of the optical magnifying combination lens.

According to one embodiment of the present invention, the optical magnifying lens set further comprises:

one piece or multiple pieces of intermediate optical elements which are placed on a distal end of the optical magnifying lens set; wherein optical information displayed by the image display source first passes through the intermediate optical elements, then passes through the optical magnifying lens set and reaches the human eyes.

According to one embodiment of the present invention, the multiple intermediate optical elements comprise a focusing thin optical element, or a convex lens, or a combination of the focusing thin optical element and the convex lens.

Another object of the present invention is to provide a head-mounted virtual reality display device, wherein the display device comprises a set or two sets of the head-mounted display optical system.

Compared to the conventional technology, the present invention has the following benefits:

1. The optical magnifying combination lens provided by the present invention adopts a structure combines the conventional lens and a focusing thin optical element. When the optical magnifying combination lens is applied on the head-mounted virtual reality display device, the central image quality are guaranteed and the peripheral field of view of the human eye is enlarged, which enhance the user immersion;

2. The weight of the head-mounted virtual reality display device is reduce to a great extend due to the use of the focusing thin optical element, which relives the user's uncomfortable feeling caused by the weight;

3. The combination of the normal convex lens without skirts and the focusing thin optical element with a hollow-out region in the center easily causes skew and dislocation, which affects the accuracy of the optical magnifying combination lens. The present invention provides optical magnifying combination lens which adopts convex lens with skirt to stack with the focusing thin optical element, which is able to effectively reduce the difficulty of combining the convex lens and the focusing thin optical element and improve the yield of the optical magnifying combination lens.

Other features and advantages of the present invention are explained in the following specifications, which becomes obvious and understandable with the description in the specification and embodiment. The objects and advantages of the present invention are able to be realized by the structure explained and illustrated in the specification, claims and figures.

### BRIEF DESCRIPTION OF THE DRAWINGS

In order to better illustrate the technical solutions of the embodiments of the present invention and the conventional technology, a brief introduction of the figures required are listed as below. Obviously, the figures described below are just embodiments of the present invention. For a skilled technician in the field, other figures are able to be obtained based on the figures without innovative effort.

FIG. 1 is a perspective view of a breakdown structure of an optical magnifying combination lens of an embodiment according to the present invention;

FIG. 2 is a sectional drawing of the elements in the FIG. 1;

FIG. 3 is a perspective view of the optical magnifying combination lens with the assembled structure in the FIG. 1;

FIG. 4 is a perspective view of a breakdown structure of an optical magnifying combination lens of another embodiment according to the present invention;

FIG. 5 is a perspective view of the optical magnifying combination lens with the assembled structure in the FIG. 4;

FIG. 6 is a perspective view of a structure of main lens of the optical magnifying combination lens of an embodiment according to the present invention;

FIG. 7 is a perspective view of a structure of secondary lens corresponding to the main lens in the FIG. 6;

FIG. 8 is a perspective view of the elements of the optical magnifying combination lens in light paths of an embodiment according to the present invention;

FIG. 9 is a perspective view of the structure of a head-mounted display optical system of an embodiment according the present invention;

FIG. 10 is optical parameters annotation drawings of a central area and an peripheral area of the optical magnifying combination lens in the head-mounted display optical system illustrated in the FIG. 9 and FIG. 14;

FIG. 11 is a perspective view of the structure of the head-mounted display optical system of another embodiment according to the present invention;

FIG. 12 is a perspective view of the structure of the head-mounted display optical system of another embodiment according to the present invention;

FIG. 13 is optical parameters annotation drawings of a central area and a peripheral area of the optical magnifying combination lens in the head-mounted display optical system illustrated in the FIG. 12;

FIG. 14 is a perspective view of the structure of the head-mounted display optical system of another embodiment according to the present invention;

FIG. 15 is optical parameters annotation drawing of convex lens 4 in the FIG. 14;

FIG. 16 is a perspective view of the structure of the head-mounted display optical system of another embodiment according to the present invention.

Element numbers: A—central area of an optical magnifying combination lens; B—peripheral area of an optical magnifying combination lens; 1—image display source; 2—optical magnifying combination lens; 3—focusing thin optical element; 4—convex lens.

### DETAILED DESCRIPTION OF THE PREFERRED EMBODIMENT

Referring to the drawings, the technical solutions in the embodiments of the present invention are clearly and fully illustrated. Obviously the embodiments are just part of the embodiments of the present invention. All the embodiments based on the illustrated embodiments, which are conceived by a skilled technician in the field without innovative efforts, are within the protection range of the present invention.

The optical magnifying combination lens of the present invention is designed for the head-mounted VR (virtual reality) display system.

An optical magnifying combination lens comprises main lens and secondary lens wherein the main lens comprises a central area and an peripheral area; the central area A which is a convex lens (biconvex or plano-convex) or combined lens; the peripheral area B is a focusing thin optical element (a thin optical element obtains a focusing function); the secondary lens is a focusing thin optical element formed with a hollow-out region.

In different embodiments of the present invention, the material of the central area A and the peripheral area B of the main lens is able to be same (such as the optical plastic PMMA (Poly(methyl methacrylate)) or is able to be different (such as the central area adopts the optical plastic PMMA while the peripheral area adopts ZEONEX® E48R. The present invention is not limited by the material listed as an example.

In practical use, when the optical magnifying combination lens is formed by one piece of main lens, the focal lengths of the central area and the peripheral area of the main lens are similar. Similar focal lengths of the central area and the focusing thin optical elements of the main lens tend to cause big difference in the central thickness of the central area and the focusing thin optical element; wherein the peripheral area of the main lens is big and thin which requires high standard injection molding techniques, especially when the main lens adopts integrally molded, the requirement for the injection molding techniques is with higher standard. The present invention adopts a secondary lens as a compensate lens to stack with the peripheral area of the main lens, which enables the peripheral area of the main lens has bigger focal length and increases the thickness of the peripheral area of the main lens. The present invention effectively lowers the producing techniques requirements and reduces the injection molding cost.

In the present invention the main lens is stacked with the secondary lens; the hollow-out region of the secondary lens is closely fit with a convex portion of the central area of the main lens; wherein the central area of the main lens corresponds to the prime-view field imaging, which ensures the VR display system adopts the optical magnifying combination lens has high quality image. The secondary lens corresponds to the edge-view field imaging, which is able to effectively enlarge the peripheral field of the VR display system.

The combined convex lens refers to a convex lens set with at least two pieces of convex lens, such as two pieces of round aspheric lens with the same diameter cemented together to form a combined convex lens. In the present embodiment, the peripheral area (the transparent flat skirt of the convex lens) of the main lens has no optical function, which is mainly for the convenience to combine the convex lens of the main lens with the secondary lens. In the present embodiment, preferably, lines for removing the chromatic aberration are carved on the surface of the central area of the main lens of the optical magnifying combination lens, that is the central area of the main lens is able to be a refractive-diffractive hybrid achromatic lens.

In the different embodiments of the present invention, the convex lens of the main lens is able to be conventional spherical lens, aspheric lens or free-form optical lens which is not a limitation for the present invention. In the different embodiments of the present invention the secondary lens is Fresnel lens, Fresnel zone plate or a binary optical element etc. which are not a limitation for the present invention.

For example, in one embodiment of the present invention, the convex lens forms the central area of the main lens is an aspheric lens while the peripheral area of the main lens and the secondary lens are Fresnel lenses of the same shape and size on flat substrates, wherein one side of the flat substrate Fresnel lens is smooth and the other side forms concentric serrated circles. When the optical magnifying combination lens is applied on the head-mounted VR display device, the smooth side of the Fresnel lens preferably faces the human eyes.

The outline of the central area of the main lens is verified, which is able to be round, rectangle or other irregular shape. The outline of the hollow-out region of the secondary lens matches and closely fits the outline of the central area of the main lens.

In the present embodiment, the overlapping focal length of the peripheral area of the main lens stacking with the secondary lens is similar with the central area of the main lens. The overlapping focal length is approaching the focal length of the central area of the main lens. Specifically, in the embodiment, the difference between the overlapping focal length of the peripheral area of the main lens stacking with the secondary lens and the focal length of the central area of the main lens is within 10 millimeters.

In the embodiment, the main lens is combined with the secondary lens by optical cement. In other embodiments of the present invention, reasonable combination methods are able to be adopted for the main lens and the secondary lens, such as the mechanical combination method. The combination methods are not a limitation for the present invention.

In different embodiments of the present invention, the secondary lens is able to be assembled at different sides of the main lens. When the optical magnifying combination lens is applied on a head-mounted display device, the secondary lens is able to be located on the distal side of the main lens from the human eyes or the proximal side from the human eyes.

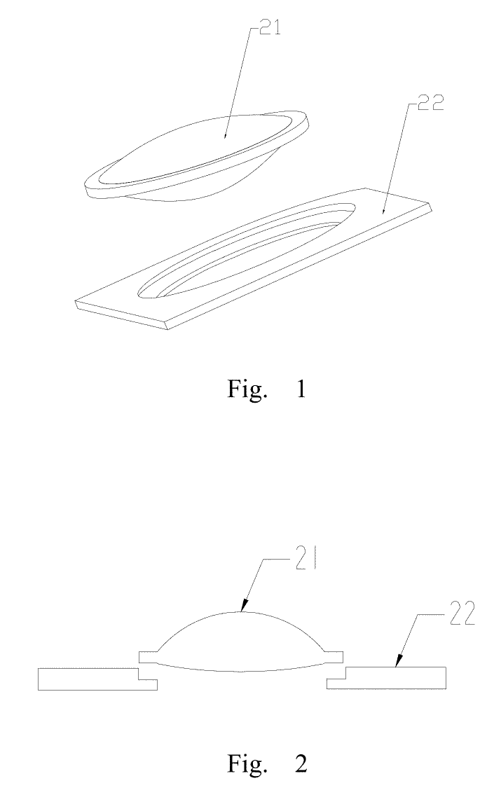

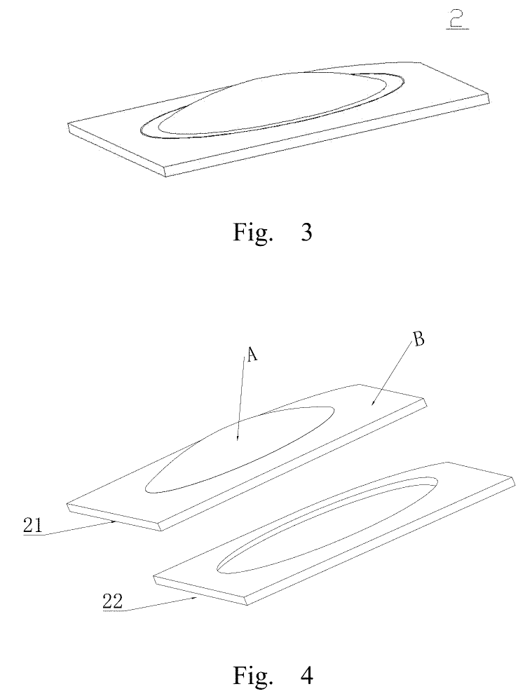

FIG. 1 to FIG. 3 is a perspective view of the optical magnifying combination lens of an embodiment according to the present invention.

As illustrated in FIG. 1 to FIG. 3, the optical magnifying combination lens 2 comprises the main lens 21 and the secondary lens 22, wherein the main lens 21 is a set of convex lens with transparent small skirt; the secondary lens 22 is a set of flat substrate Fresnel lens with a hollow-out region in the center. A sinking overlapping edge is on the internal edge of the secondary lens 22; wherein the overlapping edge matches the skirt of the main lens 21. When the main lens 21 is combined with the secondary lens 22, the main lens 21 is closely embedded in the central hollow-out region of the secondary lens 22 and the skirt of the main lens 21 is overlapped with the sinking overlapping edge of the secondary lens 22.

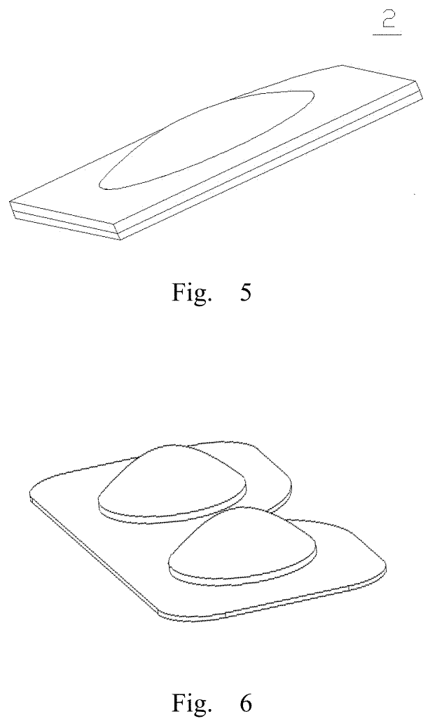

The FIG. 4 and FIG. 5 illustrate the optical magnifying combination lens in another embodiment according to the present invention. As illustrated in the FIG. 4 and FIG. 5, the main lens 21 in the optical magnifying combination lens 2 is a set of convex lens 21 with big transparent skirt; the secondary lens 22 is a set of flat substrate Fresnel lens with a hollow-out region in the center; wherein the shape and size of the skirt of the main lens 21 is same with the shape and size of the secondary lens 22. When the main lens 21 stacks with the secondary lens 22, the skirt of the main lens 21 is fully overlapped with the secondary lens 22.

The transparent flat skirt of the convex lens (the peripheral area of the main lens 21) has no optical function, which is mainly for the convenience to combine the convex lens with the focusing thin optical element which forms the secondary lens 22. The size and shape of the skirt of the convex lens is able to be different and partly overlap with the focusing thin optical element.

The head-mounted VR display device is able to be applied for single or both eyes. The optical magnifying combination lens illustrated in the FIG. 1 to FIG. 5 has one central area, which is able to be applied for single eye or both eyes. For the light path, the binocular head-mounted VR display device requires two set of optical system to match the left and right eyes respectively. For the structure of the product, part of the bilateral symmetric optical elements of the required two sets of the optical system in the binocular head-mounted VR display device are able to be integrally molded which is convenient for production and assembly.

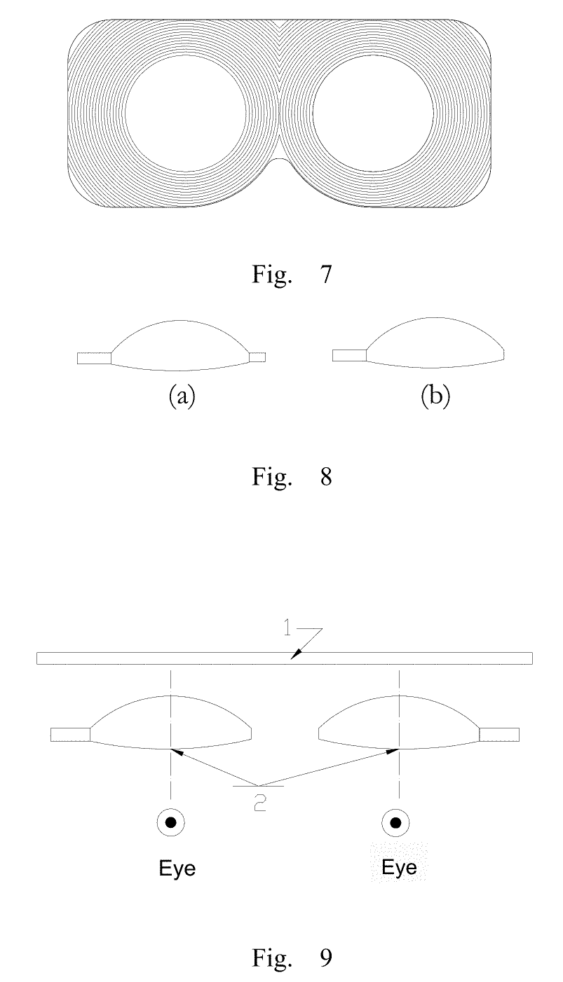

For example, when the pupil spacing of the binocular head-mounted VR display device does not require adjustment, as illustrated in the FIG. 6 and FIG. 7, the main lens and the secondary lens of the left and right optical magnifying combination lens are able to be designed as integrally molded. The main lens of the optical magnifying combination lens is designed to have two central areas which are bilateral symmetric and the number of the central hollow-out regions of the secondary lens matches the number of the central area of the main lens.

The optical magnifying combination lens is a nonstandard lens, which is illustrated in the light path in FIG. 8(a) and FIG. 8(b).

The present invention provides a head-mounted display optical system which adopts the optical magnifying combination lens. The head-mounted display optical system comprises the image display source and the optical magnifying lens set. The image display source is applied for display the optical information which reaches the human eyes after being enlarged by the optical magnifying lens set; wherein the optical magnifying lens set comprises at least one piece of the optical magnifying combination lens.

In the different embodiments of the present invention, the image source display source is able to be realized with different reasonable methods which are not a limitation of the present invention. The image display source is able to be a single display screen or mobile terminal display.

In the embodiments of the present invention, the optical magnifying lens set comprises one piece or multiple pieces of intermediate optical elements. The intermediate optical elements are set on the distal side of the optical magnifying combination lens from the human eyes. The optical information of the image display source first passes through the intermediate optical elements and then passes through the optical magnifying combination lens before reaches the human eyes.

In the different embodiments of the present invention, the intermediate optical elements may be a focusing thin optical element, a convex lens or a combination of the focusing thin optical element and the convex lens which is not a limitation for the present invention.

In an embodiment of the present invention, the intermediate optical element is a focusing thin optical element which is set on the distal side of the optical magnifying combination lens from the human eyes. The optical information displayed by the image display source first passes through the focusing thin optical element, then passes through the optical magnifying combination lens before reaches the human eyes.

In another embodiment, the intermediate optical element is a convex lens which is set on the distal side of the optical magnifying combination lens from the human eyes. The optical information displayed by the image display source first passes through the convex lens, then passes through the optical magnifying combination lens before reaches the human eyes. The convex lens is able to be the conventional spherical lens, aspheric lens, free-form optical lens or a combination of the conventional lens which are within the protection range of the present invention.

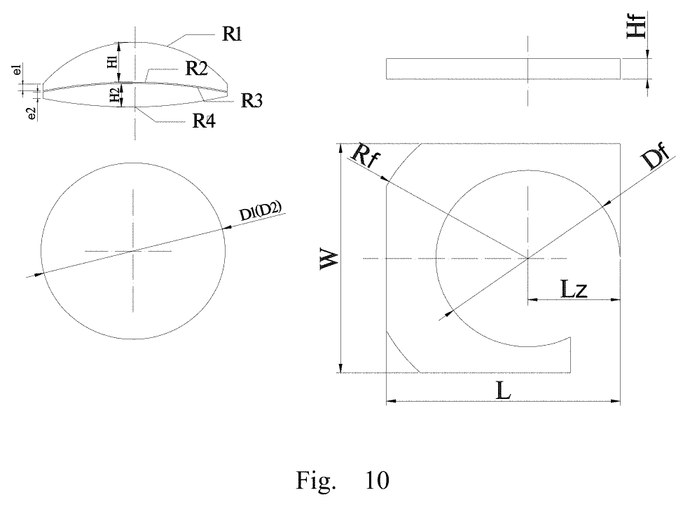

The below embodiments are illustrated by the FIG. 9 to FIG. 16. The FIG. 9 to FIG. 16 are examples of the binocular head-mounted display optical system. The monocular optical system is able to be produced by choosing one side of the binocular optical system, and there is no need for separated description.

The FIG. 9 is a perspective view of the structure of the binocular head-mounted display optical system of an embodiment according to the present invention.

As illustrated in the FIG. 9, the binocular head-mounted display optical system comprises the image display source 1 (the image display source 1 is able to be one big display screen divided into the left and the right part, or two separated small left and right screens) shared by the left and the right eyes and the left and the right optical magnifying lens sets. Each set of the optical magnifying lens comprises one piece of the optical magnifying combination lens 2. The projected virtual image of optical information displayed by the image display source 1 after being enlarged by the optical magnifying combination lens 2 is received by the human eyes.

The head-mounted display optical system as illustrated in the FIG. 9 comprises the optical magnifying combination lens 2, wherein the central area (the convex lens part) of the main lens is formed by two round aspheric lens with the same diameter cemented together (the two aspheric lens have identical skirt). The secondary lens is the focusing thin optical element with a central hollow-out region, wherein preferably a flat substrate Fresnel lens is adopted. The structures of the central area of the main lens of the optical magnifying combination lens 2 and the secondary lens are annotated as in the FIG. 10. The respective parameters of the central area and the secondary lens are listed in the table 1.

TABLE 1

| Main | Central area | Lens | Radius of | Aspheric | Radius of | Central | Edge | Diameter | Focal | Material |
|---|---|---|---|---|---|---|---|---|---|---|
| lens | A(cemented | 1 | curvature R1 | coefficient | curvature R2 | thicknessH1 | thickness e1 | D1 | length | |
| | lens) | | 19.85 | K = −2.155 | 468.39 | 14.6 | 2.3 | 54 | 37.1 | PMMA |
| | | Lens | Radius of | Aspheric | Radius of | Central | Edge | Diameter | Focal | Material |
| | | 2 | curvatureR4 | coefficient | curvature R3 | thicknessH2 | thickness e2 | D2 | length | |
| | | | 56.47 | K = −2.098 | 468.39 | 8.9 | 1.69 | 54 | 94.8 | POLYCARB |

| | | | | | | | | |
|---|---|---|---|---|---|---|---|---|
| Fresnel lens | Rf | W | L | Lz | Thickness | Df | Focal | Material |
| | on the edge | | | | | Hf | | length |
| | 40 | 70 | 72 | 31 | 3 | 54.05 | 60.3 | PMMA |

| | | | | | | | | |
|---|---|---|---|---|---|---|---|---|
| Secondary lens | Rf | W | L | Lz | Thickness | Df | Focal | Material |
| (Fresnel lens) | | | | | Hf | | length | |
| | 40 | 70 | 72 | 31 | 3 | 54.05 | 59.6 | PMMA |

In the embodiment, when the optical magnifying combination lens 2 match the parameters listed in the table 1, the focal length of the central area of the main lens and the secondary lens are both 30 mm (the total focal length of the optical magnifying lens is 30 nm). When the image display source 1 is a 6-inch screen, the binocular horizontal view of the head-mounted display optical system is around 106 degrees and the diagonal field of view is around 152 degrees.

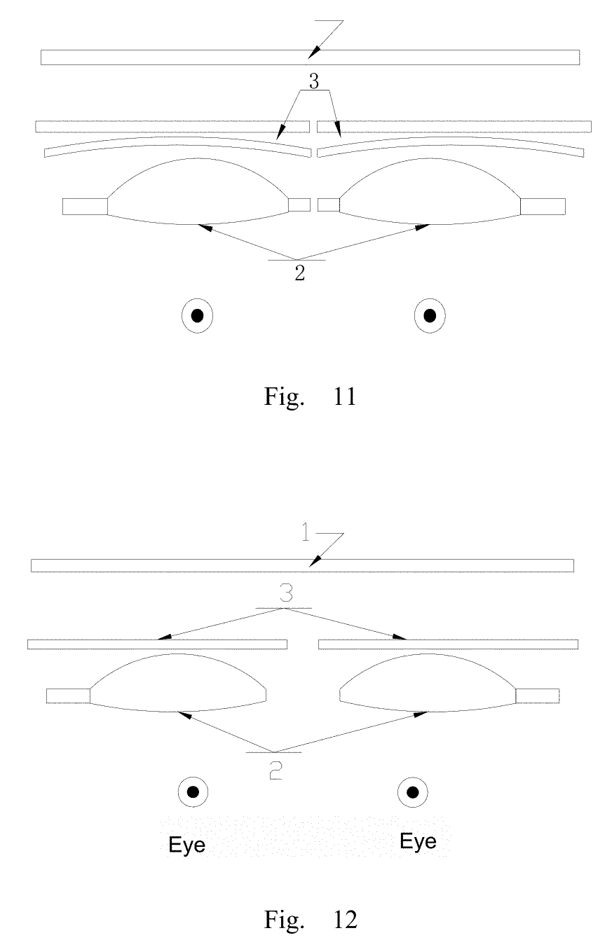

FIG. 11 is a perspective view of the structure of the binocular head-mounted display optical system in another embodiment according to the present invention.

As illustrated in the FIG. 11, the binocular head-mounted display optical system comprises an image display source 1 and the left and the right set optical magnifying lens set; wherein each set of the optical magnifying lens comprises one piece of optical magnifying combination lens 2 and two pieces of focusing thin optical element 3. The two pieces of focusing thin optical element 3 are set between the optical magnifying combination lens 2 and the image display source 1. In the embodiment, the two pieces of the focusing thin optical element 3 of each set of the optical magnifying lens is able to be one piece of flat substrate Fresnel lens and one piece of arc substrate Fresnel lens. The optical information displayed in the image display source 1 first passes through the focusing thin optical element 3, then passes through the optical magnifying combination lens 2 before reaches the human eyes.

FIG. 12 is a perspective view of the structure of the binocular head-mounted display optical system in another embodiment according to the present invention.

As illustrated in the FIG. 12, the binocular head-mounted display optical system comprises an image display source 1 and the left and the right set optical magnifying lens set; wherein each set of the optical magnifying lens comprises one piece of optical magnifying combination lens 2 and one piece of focusing thin optical element 3 (in the embodiment, the focusing thin optical element 3 preferably adopts a flat substrate Fresnel lens). The optical information displayed in the image display source 1 first passes through the Fresnel lens 3, then passes through the optical magnifying combination lens 2 before reaches the human eyes.

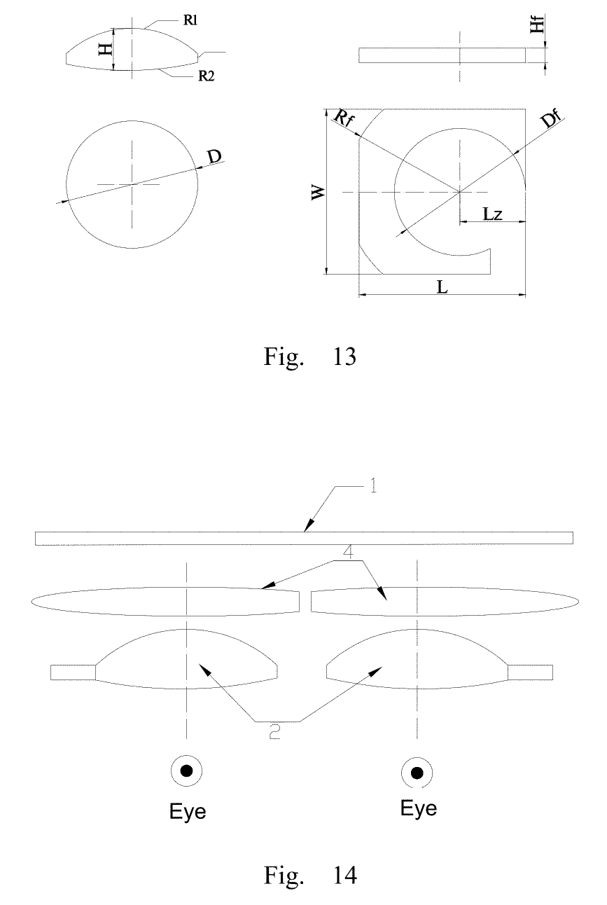

In the embodiment, the optical magnifying combination lens 2 comprises a round aspheric lens with a skirt and a flat substrate Fresnel lens with a central hollow-out region. The structures of the aspheric lens part of the optical magnifying combination lens 2 and the peripheral Fresnel lens part are annotated in the FIG. 13. The respective parameters of the aspheric lens and the peripheral Fresnel lens are listed in the table 2.

TABLE 2

| | | | | | | | | | |
|---|---|---|---|---|---|---|---|---|---|
| Main | Aspheric lens | Radius of | Aspheric | Radius of | Central | Edge | Diameter | Focal | Material |
| lens | (central area A) | curvatureR1 | coefficients | curvature R2 | thickness H | thickness e | D | length | |
| | | 35.72 | K = −0.689 | 360 | 11.6 | 2 | 48 | 60 | PMMA |
| | | | a4 = −0.0000063 | | | | | | |
| | Edge Fresnel | Rf | W | L | Lz | Thickness Hf | Df | Focal | Material |
| | lens part | | | | | | | length | |
| | (peripheral | 40 | 70 | 72 | 31 | 2 | 48.05 | 120 | PMMA |
| | area B) | | | | | | | | |

| | | | | | | | | |
|---|---|---|---|---|---|---|---|---|
| Secondary lens | Rf | W | L | Lz | ThicknessHf | Df | Focal | Material |
| (Fresnel lens) | | | | | | | length | |
| | 40 | 70 | 72 | 31 | 2 | 48.05 | 120 | PMMA |

In the embodiment, when the optical magnifying combination lens 2 matches the parameters listed in the table 2, the image display source 1 is a 6-inch screen and the focal length of the Fresnel lens 3 is 55 mm, the total focal length of the optical magnifying lens is 29 mm. The binocular horizontal field angle of the optical system is around 110 degrees and the diagonal field of view is around 160 degrees.

FIG. 14 is a perspective view of the structure of the binocular head-mounted display optical system in another embodiment according to the present invention.

As illustrated in the FIG. 14, the binocular head-mounted display optical system comprises an image display source 1 and the left and the right set optical magnifying lens set; wherein each set of the optical magnifying lens comprises one piece of optical magnifying combination lens 2 and one piece of convex lens 4. The optical information displayed in the image display source 1 first passes through the convex lens 4, then passes through the optical magnifying combination lens 2 before reaches the human eyes.

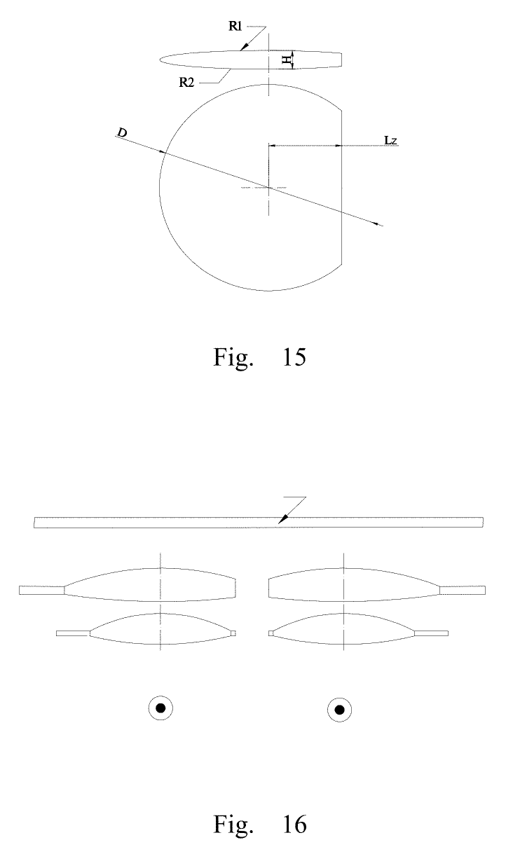

In the embodiment, the optical magnifying combination lens 2 comprises a main lens and a secondary lens; wherein the main lens is a round aspheric lens with skirt; the secondary lens is a flat substrate Fresnel lens with a central hollow-out region. The structures of the aspheric lens part of the optical magnifying combination lens 2 and the peripheral Fresnel lens part are annotated in the FIG. 15. The respective parameters of the aspheric lens and the peripheral Fresnel lens are listed in the table 3. When the convex lens 4 is an aspheric biconvex, the structure is annotated in the FIG. 16 and the respective parameters are listed in the table 4.

TABLE 3

| | | | | | | | | | |
|---|---|---|---|---|---|---|---|---|---|
| Main | Aspheric lens | Radius of | Aspheric | Radius of | Central | Edge | Diameter | Material | Focal |
| Lens | (central area A) | curvature R1 | coefficients | curvature R2 | thickness H | thickness e | D | | length |
| | | 26.6 | K = −0.9 | 130.085 | 12.3 | 1.54 | 46 | PMMA | 45.95 |
| | | | a4 = −3.43E−6 | | | | | | |
| | | | a6 = −5.83E−9 | | | | | | |
| | Edge Fresnel | Rf | W | L | Lz | Thickness | Df | Material | Focal |
| | lens part | | | | | Hf | | | length |
| | (peripheral | 40 | 70 | 72 | 31 | 2 | 46.05 | PMMA | 92 |
| | area B) | | | | | | | | |

| | | | | | | | | |
|---|---|---|---|---|---|---|---|---|
| Secondary lens | Rf | W | L | Lz | Thickness | Df | Material | Focal |
| (Fresnel lens) | | | | | Hf | | | length |
| | 40 | 70 | 72 | 31 | 2 | 46.05 | PMMA | 92 |

TABLE 4

| Aspheric | Radius of | Aspheric | Radius of | Aspheric | Central | Lz | Diameter | Material | Focal |
|---|---|---|---|---|---|---|---|---|---|
| biconvex | curvature R1 | coefficients | curvature R2 | coefficients | thickness H | | D | | length |
| | 120 | K = −0.63 | 120 | K = −0.63 | 15.3 | 31 | 80 | POLYCARB | 104.3 |

In the embodiment, when the optical magnifying combination lens 2 match the parameters listed in the table 3 and the convex lens 4 matches the parameters listed in the table 4, the total focal length of the optical magnifying lens set is 33.5 mm (the focal length of the convex lens of the optical magnifying combination lens 2 is 45.95 mm; the focal length of the peripheral Fresnel lens of the optical magnifying combination lens 2 is 46 mm and the focal length of the convex lens 4 is 104.3 mm). When the image display source 1 is a 6 inch screen, the calculated binocular horizontal field angle of the optical system is around 90 degree and the diagonal field of view is around 126 degree.

FIG. 16 is a perspective view of the structure of the binocular head-mounted display optical system in another embodiment according to the present invention.

As illustrated in the FIG. 16, the binocular head-mounted display optical system comprises an image display source 1 and the left and the right set optical magnifying lens set; wherein each set of the optical magnifying lens comprises two pieces of optical magnifying combination lens vertically stacked together. The optical information displayed in the image display source 1 first passes through the first optical magnifying combination lens, then passes through the second optical magnifying combination lens before reaches the human eyes.

In order to fulfill certain specific needs, the optical elements in the head-mounted display optical system provided by the embodiments is able to be selectively add anti-reflective coating, such as functional coatings like hard coating and anti fog coating.

In the embodiments of the head-mounted display optical system, as illustrated in the FIG. 9 to FIG. 16, the left and the right optical magnifying lens set are independent elements. When the pupil spacing of the binocular head-mounted VR display device does not require adjustment, the convex lens with skirt and the focusing thin optical element with a central hollow-out region of the left and the right optical magnifying combination lens are able to be designed as integrally molded. The convex lens and the focusing thin optical element are combined together by optical cement to form a one-body optical magnifying combination lens suitable for both eyes.

The present invention further provides a head-mounted virtual reality display device which is able to be applied for single eye or both eyes. The optical system adopts the optical magnifying combination lens of the present invention. The binocular optical system is illustrated in the FIG. 9 to the FIG. 16.

The present invention adopts a special optical magnifying combination lens which is able to significantly enlarge the field of vision of the image display system. When the optical magnifying combination lens is applied in the binocular head-mounted virtual reality display device, images with optical parallax are display on the left and the right screen by the image display source of the device, which is able to bring immense visual impact and shock to the user by the stereoscopic vision.

The present invention overcomes the problems of small diameter of the lens limiting the field of vision of the display system, reducing the user immersion, increasing the weight and bringing uncomfortable wearing experience to the user by solely adopting the conventional lens (spherical lens, aspheric lens or free-form optical lens) as the magnifying lens set for the head-mounted display device.

The focusing thin optical element in the present invention comprises thin optical elements with focusing function such as a Fresnel lens, Fresnel zone plate or binary optical element. The weight of the thin optical elements is light but the imaging quality is low. To combine the thin optical elements with the conventional lens is able to ensure the central image quality, and expands a peripheral field of view of a human eye, thus increasing user immersion. By adopting the focusing thin optical elements the weight of the system is significantly reduced, which relaxes the uncomfortable experience of the user.

Besides, the combination of the normal convex lens without skirts and the focusing thin optical element with a hollow-out region in the center easily causes skew and dislocation, which affects the accuracy of the optical magnifying combination lens. The present invention provides optical magnifying combination lens which adopts convex lens with skirt to stack with the focusing thin optical element, which is able to effectively reduce the difficulty of combining the convex lens and the focusing thin optical element and improve the yield of the optical magnifying combination lens.

The features, methods and procedures disclosed in the present invention are able to be combined arbitrarily except the conflicted features and/or steps.

Any features disclosed in the specifications (including any extra claims, abstracts and drawings) are able to be replaced with features with similar effects and function except explained otherwise, that is except being explained otherwise, every feature is just an example for a series feature with similar effects.

The present invention is not limited by the embodiments. The present invention is able to be extended to any new features and methods or new combinations of the features and methods disclosed in the specifications.

1. An optical magnifying combination lens applied in a head-mounted virtual reality display device, comprising a main lens and a secondary lens wherein:
the main lens comprises a central area and a peripheral area; the central area comprises convex lens or combined convex lens;
the secondary lens is a focusing thin optical element formed with a hollow-out region in a center;
wherein the main lens is stacked with the secondary lens; the hollow-out region of the secondary lens is closely fit with a convex portion of the central area of the main lens.

2. The optical magnifying combination lens, as recited in claim 1, wherein when the main lens is stacked with the secondary lens, the peripheral area of the main lens is partially or fully stacked with the secondary lens.

3. The optical magnifying combination lens, as recited in claim 1, wherein a sinking overlapping edge lies in an internal edge of the secondary lens; the overlapping edge fits the peripheral area of the main lens.

4. The optical magnifying combination lens, as recited in claim 1, wherein a difference between an overlapping focal length of the peripheral area of the main lens and the secondary lens and a focal length of the central area of the main lens is less than 10 millimeters.

5. The optical magnifying combination lens, as recited in claim 1, wherein,
the convex lens is spherical lens, aspheric lens or free-form optical lens; and/or,
the secondary lens is Fresnel lens, Fresnel zone plate or a binary optical element.

6. The optical magnifying combination lens, as recited in claim 5, wherein the convex lens of the central area of the main lens is aspheric lens; the peripheral area of the main lens and the secondary lens is Fresnel lenses of a same shape and size on flat substrates.

7. The optical magnifying combination lens, as recited in claim 5, wherein lines for removing chromatic aberration are on a surface of the convex lens.

8.-14. (canceled)

15. The optical magnifying combination lens, as recited in claim 1, wherein the main lens is stacked with the secondary lens by an optical cement.

16. The optical magnifying combination lens, as recited in claim 3, wherein the main lens is stacked with the secondary lens by an optical cement.

17. The optical magnifying combination lens, as recited in claim 6, wherein the main lens is stacked with the secondary lens by an optical cement.

18. The optical magnifying combination lens, as recited in claim 1, wherein the central area and the peripheral area of the main lens are integrally injection molded.

19. The optical magnifying combination lens, as recited in claim 3, wherein the central area and the peripheral area of the main lens are integrally injection molded.

20. The optical magnifying combination lens, as recited in claim 6, wherein the central area and the peripheral area of the main lens are integrally injection molded.

21. A head-mounted display optical system, wherein the optical system comprises an image display source and an optical magnifying lens set, wherein the image display source is for displaying optical information; the optical information is magnified by the optical magnifying lens set to form a projection virtual image which is receive by human eyes; wherein the optical magnifying lens set comprises at least one piece of an optical magnifying combination lens recited in claim 1.

22. A head-mounted display optical system, wherein the optical system comprises an image display source and an optical magnifying lens set, wherein the image display source is for displaying optical information; the optical information is magnified by the optical magnifying lens set to form a projection virtual image which is receive by human eyes; wherein the optical magnifying lens set comprises at least one piece of an optical magnifying combination lens recited in claim 6.

23. The optical system, as recited in claim 21, wherein the optical magnifying lens set comprises:
one piece or multiple pieces of intermediate optical elements which are placed on a distal end of the optical magnifying lens set; wherein optical information displayed by the image display source first passes through the intermediate optical elements, then passes through the optical magnifying lens set and reaches the human eyes.

24. The optical system, as recited in claim 23, wherein the optical magnifying lens set comprises:
one piece or multiple pieces of intermediate optical elements which are placed on a distal end of the optical magnifying lens set; wherein optical information displayed by the image display source first passes through the intermediate optical elements, then passes through the optical magnifying lens set and reaches the human eyes.

25. A head-mounted virtual reality display device, wherein the display device comprises a set or two sets of head-mounted display optical systems recited in claim 21.

26. A head-mounted virtual reality display device, wherein the display device comprises a set or two sets of head-mounted display optical systems recited in claim 22.

27. A head-mounted virtual reality display device, wherein the display device comprises a set or two sets of head-mounted display optical systems recited in claim 23.
